(19) United States
(12) Patent Application Publication
(10) Pub. No.: US 2022/0312727 A1
(43) Pub. Date: Oct. 6, 2022

(54) PET FEEDER

(71) Applicant: Huizhou du du Pet Products Co. LTD, Huizhou (CN)

(72) Inventor: Xianqiang Zhang, Xiangtan (CN)

(73) Assignee: Huizhou du du Pet Products Co. LTD, Huizhou (CN)

(21) Appl. No.: 17/842,803

(22) Filed: Jun. 17, 2022

(30) Foreign Application Priority Data
Jan. 26, 2022 (CN) 202220213289.5

(51) Int. Cl. A01K 5/02

(52) U.S. Cl. CPC A01K 5/0291; A01K 5/0225

(57) ABSTRACT

The present disclosure discloses a pet feeder, and relates to the field of pet feeding equipment. The pet feeder includes a main unit structure; an inner side of the main unit structure is provided with a division structure used for guiding pet food; a side wall of the division structure is connected with a distribution tube used for food division; a bottom end of the main unit structure is provided with a supporting base; a side wall of the supporting base is provided with a food plate structure; and the food plate structure and the supporting base are both provided with adjustment slots used for adjusting a height of the feeder.

### TECHNICAL FIELD

The present disclosure relates to the field of pet feeding equipment, in particular to a pet feeder.

### BACKGROUND

When pets are fed, in order to reduce the feeding difficulty and ensure the feeding amount and feeding time of pets, pet feeders are usually used for auxiliary feeding. However, although the feeders currently used on the market can meet the needs of regular and quantitative feeding, they still have shortcomings during use: The pet feeder cannot be adjusted according to a requirement of pets for a feeding height, and cannot achieve food division according to the number of pets to be fed. A single pet feeder can hardly satisfy multiple pets. Furthermore, such a pet feeder has poor air tightness and poor sterilization effect, so that dryness and quality of pet food are hard to guarantee. Therefore, in order to solve this problem, a pet feeder is provided.

### SUMMARY

The present disclosure provides a pet feeder, which solves the following problems: The existing pet feeder has low adjustability and small application range; it is hard for a single pet feeder to satisfy multiple pets; and the dryness and quality of pet food cannot be guaranteed.

In order to achieve the foregoing purpose, the present disclosure adopts the following technical solution:

A pet feeder includes a main unit structure; an inner side of the main unit structure is provided with a division structure used for guiding pet food; a side wall of the division structure is connected with a distribution tube used for food division; a bottom end of the main unit structure is provided with a supporting base; a side wall of the supporting base is provided with a food plate structure; the food plate structure and the supporting base are both provided with adjustment slots used for adjusting a height of the feeder; and the main unit structure, the division structure and the distribution tube are all sealed.

Preferably, the main unit structure includes a protecting shell, a transparent hood, a sealing cover plate, a controller and a camera; a top end of the protecting shell is provided with the sealing cover plate and the controller; the transparent hood is arranged between the protecting shell and the sealing cover plate; a side wall of the protecting shell is provided with the camera; an inner side of the sealing cover plate is provided with an ultraviolet (UV) lamp tube; the UV lamp tube disinfects the inside of the pet feeder; and a top end of the sealing cover plate is provided with an ambient lamp.

Preferably, the division structure includes a guide base plate and a guide device; the guide base plate is located at a bottom end of the protecting shell; the guide device is arranged on the inner side of a bottom end of the guide base plate to guide the pet food.

Preferably, a feeding end of the distribution tube is connected to a side wall of the guide base plate; and the distribution tube is adjusted and replaced according to a requirement of a division port.

Preferably, the supporting base is located at a bottom end of the main unit structure to heighten the main unit structure, so that the distribution tube is matched with the food plate structure.

Preferably, the food plate structure includes a food plate base, a partition and a food plate; the partition is arranged in the middle of the food plate base; a top end of the food plate base is provided with the food plate; the food plate is matched with the distribution tube; and a bottom end of the food plate base is provided with an adjustment slot.

Preferably, an indicator lamp module, a button module, a detection module and a sound module which are electrically connected to the controller are also arranged inside the main unit structure; the sound module includes a microphone and a horn and is used for recording sounds and playing the recorded sounds or prompt tones; the indicator lamp module includes displaying time, displaying the number of parts, displaying the number of meals, a power lamp, a lock lamp, a state lamp, and displaying insufficient food, and is used for displaying a state indication and achieving digital displaying; the button module includes UV lamp turn-on/turn-off, lighting lamp turn-on/turn-off, a “+” button, a “−” button, unlock, set, record and manual feeding reset, and includes physical buttons and touch buttons; and the detection module includes detecting remaining food, in-position, food blocking, power supplying of a battery and battery power, detecting and prompting remaining food by infrared, and reminding users to timely add food.

The present disclosure has the beneficial effects below.

1. By the arrangement of the adjustment slots, heightening columns are mounted at the bottom ends of the food plate structure and the main unit structure according to a feeding need of pets to heighten and adjust the food plate structure and the main unit structure. The phenomenon of frequent cervical spondylosis caused by the fact that pets keep their heads down to eat food is avoided, and the comfortability of pets during feeding is improved.

2. By the arrangement of the adjustable distribution tube to distribute pet food, the desired number of food outlets is set, and the pet feeder is suitable for a family raising multiple pets; the adjustability of feeding is increased; and the application range is extended.

3. The camera is arranged for monitoring and watching the states and eating actions of pets; an infrared technology is configured for detecting remaining food and making a prompt, which reminds a user to timely add food. Furthermore, a UV sterilizer is arranged on the inner side of the sealing cover plate. The food outlet and a food bucket are both sealed, so that the air tightness of the feeder is guaranteed, which keeps the quality of food in the food bucket and the dryness inside the bucket.

In conclusion, the pet feeder has high usage adjustability and wide usage range, makes pets feel comfortable during feeding, has good air tightness and sterilization effect, and effectively ensures the quality of food in the food bucket and the dryness inside the bucket.

### BRIEF DESCRIPTION OF THE DRAWINGS

FIG. 1 is a schematic diagram of a three-dimensional structure of the present disclosure;

FIG. 2 is a three-dimensional side view of the present disclosure;

FIG. 3 is an exploded schematic diagram of a three-dimensional structure of the present disclosure;

FIG. 4 is an exploded diagram of the present disclosure;

FIG. 5 is a schematic diagram of a three-dimensional structure after a sealing cover plate in the present disclosure is opened;

FIG. 6 is a schematic structural diagram of a controller in the present disclosure;

FIG. 7 is a diagram of functional modules of the present disclosure.

Reference signs in the drawings: 1: main unit structure; 101: protecting shell; 102: transparent hood; 103: sealing cover plate; 104: controller; 105: camera; 2: division structure; 201: guide base plate; 202: guide device; 3: distribution tube; 4: supporting base; 5: food plate structure; 501: food plate base; 502: partition; 503: food plate; 6: adjustment slot; 111: microphone; 1121: time displaying; 1122: displaying of the number of parts; 1123: displaying of the number of meals; 1124: power lamp; 113: lock lamp; 114: state lamp; 115: insufficient remaining food; 116: UV lamp turn-on/turn-off; 117: lighting lamp turn-on/turn-off; 118: “+” button; 119: “−” button; 110: unlock; 1101: set; 1102: record; 1103: manual feeding reset.

### DETAILED DESCRIPTION OF THE EMBODIMENTS

The technical solutions in the embodiments of the present disclosure will be described clearly and completely below in combination with the accompanying drawings of the embodiments of the present disclosure. Apparently, the described embodiments are only part of the embodiments of the present disclosure, not all embodiments.

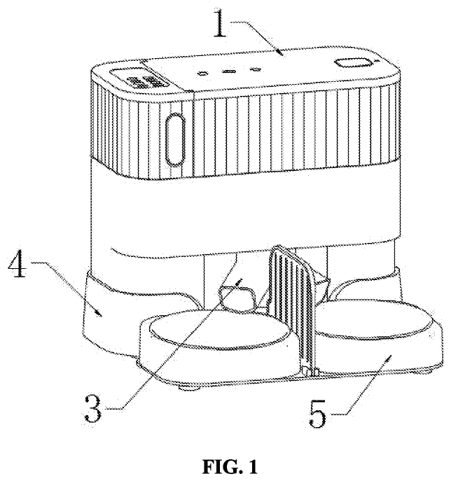

Referring to FIG. 1 to FIG. 7, a pet feeder includes a main unit structure 1; an inner side of the main unit structure 1 is provided with a division structure 2 used for guiding pet food; a side wall of the division structure 2 is connected with a distribution tube 3 used for food division; a bottom end of the main unit structure 1 is provided with a supporting base 4; a side wall of the supporting base 4 is provided with a food plate structure 5; the food plate structure 5 and the supporting base 4 are both provided with adjustment slots 6 used for adjusting a height of the feeder; and the main unit structure 1, the division structure 2 and the distribution tube 3 are all sealed.

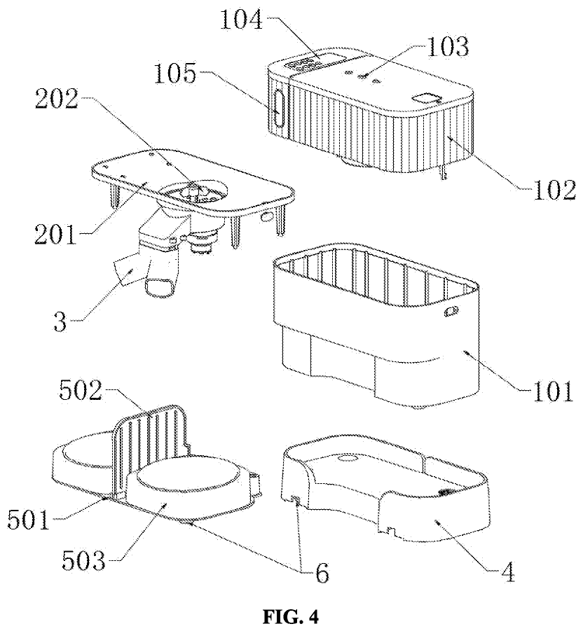

As shown in FIG. 1 and FIG. 4, the main unit structure 1 includes a protecting shell 101, a transparent hood 102, a sealing cover plate 103, a controller 104 and a camera 105. A top end of the protecting shell 101 is provided with the sealing cover plate 103 and the controller 104; the transparent hood 102 is arranged between the protecting shell 101 and the sealing cover plate 103; and a side wall of the protecting shell 101 is provided with the camera 105. An inner side of the sealing cover plate 104 is provided with a UV lamp tube; the UV lamp tube disinfects the inside of the pet feeder; and a top end of the sealing cover plate 104 is provided with an ambient lamp which is turned on by default and can be manually turned off according to a requirement. The division structure 2 includes a guide base plate 201 and a guide device 202 the guide base plate 201 is located at a bottom end of the protecting shell 101; and the guide device 202 is arranged on the inner side of a bottom end of the guide base plate 201 to guide the pet food. The camera 105 is arranged for detecting and watching states of pets and eating actions of the pets. An infrared technology is configured for detecting remaining food and making a prompt, which reminds a user to timely add food. Furthermore, a UV sterilizer is arranged on the inner side of the sealing cover plate 103. A food outlet and a food bucket are both sealed, so that the air tightness of the feeder is guaranteed, which keeps the quality of food in the food bucket and the dryness inside the bucket.

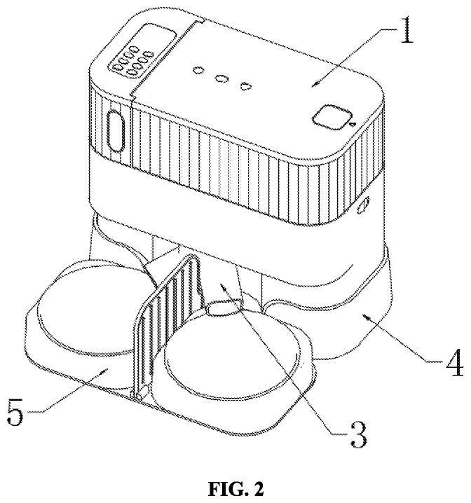

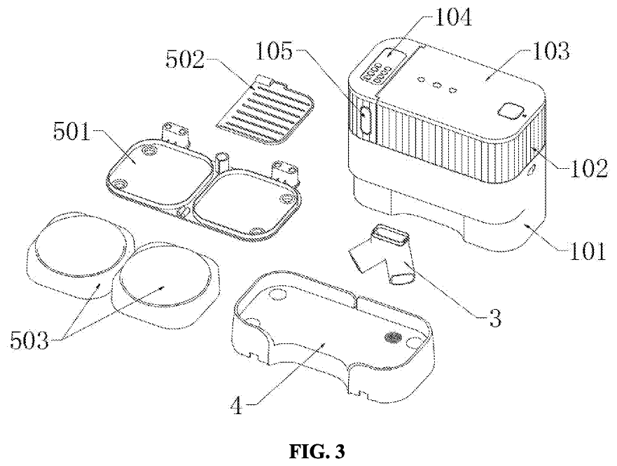

As shown in FIG. 2 and FIG. 3, a feeding end of the distribution tube 3 is connected to the side wall of the guide base plate 201; the distribution tube 3 is adjusted and replaced according to a requirement of a division port; and the supporting base 4 is located at a bottom end of the main unit structure 1 to heighten the main unit structure 1, so that the distribution tube 3 is matched with the food plate structure 5. By the arrangement of the adjustable distribution tube 3, the pet food is distributed. The desired number of food outlets is set, and the pet feeder is suitable for a family raising multiple pets; the adjustability of feeding is increased; and the application range is extended.

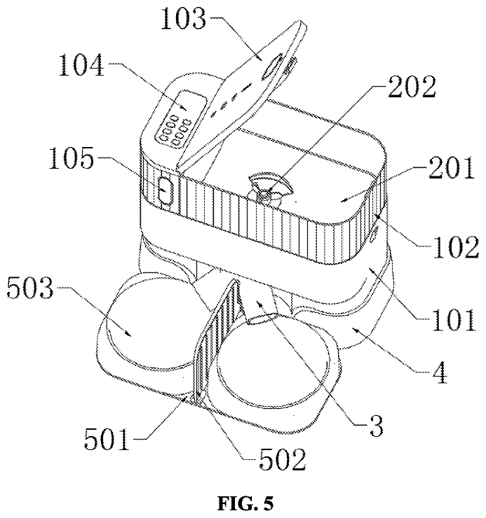

As shown in FIG. 2 and FIG. 5, the food plate structure 5 includes a food plate base 501, a partition 502 and a food plate 503; the partition 502 is arranged in the middle of the food plate base 501; a top end of the food plate base 501 is provided with the food plate 503; the food plate 503 is matched with the distribution tube 3; and a bottom end of the food plate base 501 is provided with an adjustment slot 6. By the arrangement of the adjustment slot 6, heightening columns are mounted at the bottom ends of the food plate structure 5 and the main unit structure 1 according to a feeding need of pets to heighten and adjust the food plate structure and the main unit structure. The phenomenon of frequent cervical spondylosis caused by the fact that pets keep their heads down to eat food is avoided, and the comfortability of pets during feeding is improved.

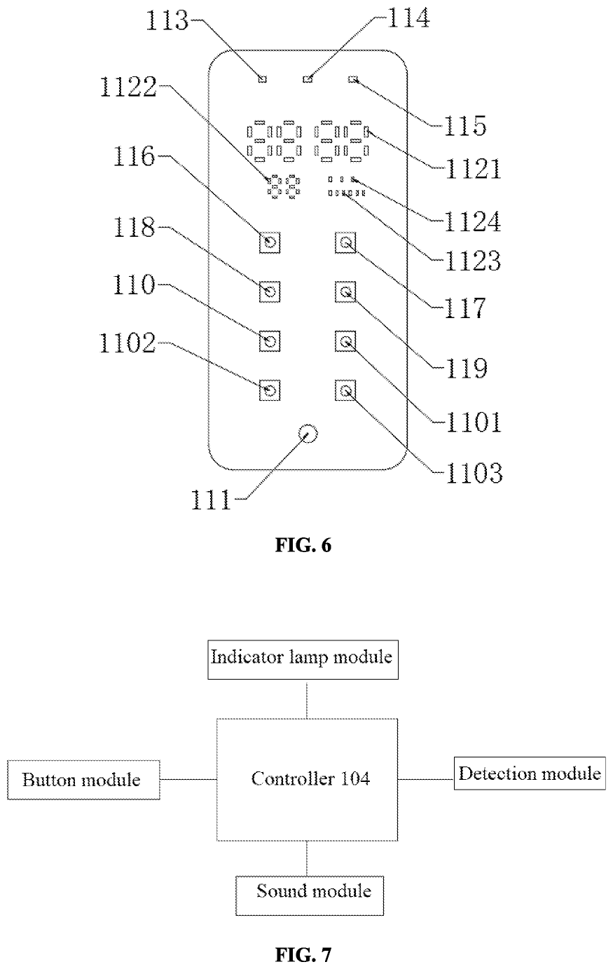

As shown in FIG. 6 and FIG. 7, an indicator lamp module, a button module, a detection module and a sound module which are electrically connected to the controller 104 are also arranged inside the main unit structure 1; the sound module includes a microphone 111 and a horn, and is used for recording sounds and playing the recorded sounds or prompt tones; the indicator lamp module includes time displaying 1121, displaying of the number of parts 1122, displaying of the number of meals 1123, a power lamp 1124, a lock lamp 113, a state lamp 114 and insufficient remaining food 115 and is used for displaying a state indication and achieving digital displaying; the button module includes UV lamp turn-on/turn-off 116, lighting lamp turn-on/turn-off 117, a “+” button 118, a “−” button 119, unlock 110, set 1101, record 1102 and manual feeding reset 1103, and includes physical buttons and touch buttons; and the detection module includes detecting remaining food, in-position, food blocking, power supplying of a battery and battery power, detecting and prompting remaining food by infrared, and reminding users to timely add food.

After the pet feeder is powered on, a screen is unlocked and in a screen-on state; after 30 seconds, the screen enters a screen locked state, and the lock lamp is correspondingly turned on; a feeding record will be updated at 0 o'clock every day; unread feeding records are erased, and a feeding record in a new cycle is shown. A long press is made to record 1102 for 3 seconds, and recording is started after “click” is heard. After the button is released, “click click” will be heard, and the recording stops. The recording duration is 10 seconds at maximum. A long press is made to set 1101 until the digit on the time displaying 1121 on the screen flickers, and then the time can be adjusted through the “+” button 118 and the “−” button 119. A short press is made to set 1101 to enter minute adjustment. A short press is made to set 1101 to set the number of meals. When the cursor flickers at the position of displaying of the number of meals 1123, the number of meals is confirmed through the “+” button 118 and the “−” button 119. Set 1101 is pressed again to enter time adjustment. After the time adjustment is completed, set 1101 is pressed to enter adjustment of the number of parts. The number of parts is displayed by displaying of the number of parts 1122. Finally, set 1101 is pressed to complete the adjustment. In the screen-locked state, a long press is made to manual feeding reset 1103 for 5 seconds, and after “click click” is heard, the equipment is restored to factory settings, and the feeding plan, the current time and the records are cleared.

The working principle: During use of the pet feeder, the heightening column is first added in the adjustment slot 6 according to a feeding requirement to adjust the feeding height of the pet feeder. The sealing cover plate 103 is opened through the tube controller 104. The sealing cover plate 103 is opened to enable the protecting shell 101 to be in an opened state. Food for feeding is added into the protecting shell 101, and the sealing cover plate 103 is then closed to achieve sealed storage for the added food and sterilize the food through the UV sterilizer in the sealing cover plate 103, so as to keep the quality of the food in the food bucket and the dryness inside the bucket. The feeding amount and a time interval are set through the controller 104 according to a feeding requirement. At the feeding time, the guide device 202 is automatically turned on. The food in the bucket is guided through the guide base plate 201 and is conveyed into the food plate 503 through the distribution tube 3 to feed pets. The specification of the distribution tube 3 can be adjusted according to the number of pets to be fed.

During use, the pets and the eating actions of the pets are monitored and watched through the camera 105, and the infrared technology is configured for detecting the remaining food and making a prompt. A digital display reminds a user to timely add food.

During use of the pet feeder, manual feeding and planned feeding can be performed according to a feeding requirement. For manual feeding, pets are directly fed through the manual feeding reset 1103 on the controller 104. At this time, the pet feeder discharges food immediately, and a recording will be played once at the same time. For planned feeding, a feeding plan is set through the controller, and the plan is saved at an equipment side. The pet feeder supports single feeding and cyclic feeding from Monday to Sunday, and the number of feedings is zeroed every day. The pet feeder supports at most 6 meals, and can make at most 20 parts of food at each meal. The feeding plan is accurate to minute, and regular feeding can be achieved. At the same time, a recording will be played once. After manual feeding and automatic feeding succeed, a successful feeding record will be added in their feeding records.

Furthermore, the manual feeding and the automatic feeding are both performed on the basis of a self-inspection time window, liquid crystal display (LCD) detection, time stop detection, motor detection and horn detection. In the self-inspection time window, after the equipment is powered on within 30 seconds, a long press is made to both an up button and a down button for 6 seconds to trigger a self-inspection function. If the self-inspection function is not triggered after the equipment is powered on for 30 seconds, this function fails. If a long press is made again to the up button and the down button and the function still cannot be triggered, the equipment needs to be powered off and then powered on, and this function can be triggered by repeating this operation.

During LCD detection, after the equipment is powered on within 30 seconds, a long press is made to both the up button and the down button to trigger a self-inspection program, and the entire LCD screen displays content for 7 seconds, so that whether the screen displaying is complete and whether there is a picture missing.

During time stop detection, when the equipment is used normally, a time marker flickers all the time. If the time marker does not flicker, a fault code E0:01 is displayed, which may be possibly caused by the following reasons:

a) there is no crystal oscillator;

b) a crystal oscillator fails;

c) an integrated circuit (IC) of a clock fails.

During motor detection, after the self-inspection function is triggered, a motor runs 6 times before stopping, and the screen displays that there are 6 meals, which indicates that the equipment is normal. If the motor fails, a fault code E0:02 is displayed, which may be possibly caused by the following reasons:

a) the motor does not run;

b) a limitation switch detects no signal;

c) the motor runs all the time.

During horn detection, after the self-inspection function is triggered, a horn will make a sound, which indicates that the horn function is normal. If no sound is made, it indicates that the horn is abnormal.

Furthermore, abnormal warning will be pushed in both cases of a feeding success and an equipment failure.

The above descriptions are only specific preferred implementation modes of the present disclosure, but the scope of protection of the present disclosure is not limited thereto. For any person skilled in the art, within the technical scope disclosed by the present disclosure, equivalent substitutions or changes made according to the technical solution of the present disclosure and an inventive idea of the present disclosure shall all fall within the scope of protection of the present disclosure.

What is claimed is:

1. A pet feeder, comprising a main unit structure, in which pet food is accommodated; a division structure which is arranged in the main unit structure and guides the pet food; a distribution tube which is connected to a side wall of the division structure and is used for dividing the pet food; a food plate structure which is arranged at a bottom end of the main unit structure; and an adjustment slot which is provided with a base of the food plate structure and is used for adjusting a height of the feeder, wherein the main unit structure, the division structure and the distribution tube are all sealed.

2. The pet feeder according to claim 1, comprising a main unit structure, wherein a bottom end of the main unit structure is provided with a supporting base; the food plate structure is arranged on the supporting base; an adjustment slot is arranged below the supporting base; and the adjustment slot adjusts a height of the feeder.

3. The pet feeder according to claim 2, comprising a main unit structure, wherein the adjustment slot is detachably connected with a heightening column; and the heightening column achieves heightening and deployment of the feeder.

4. The pet feeder according to claim 1, wherein the main unit structure comprises a protecting shell, a transparent hood, a sealing cover plate, a controller and a camera; the pet food is accommodated in the protecting shell; the sealing cover plate and the controller are arranged at a top end of the protecting shell; the sealing cover plate achieves a sealing function; the controller performs corresponding control; the transparent hood is arranged between the protecting shell and the sealing cover plate; the camera is arranged on a side wall of the protecting shell; and the camera detects and watches pets and eating actions of the pets.

5. The pet feeder according to claim 4, wherein an inner side of the sealing cover plate is provided with an ultraviolet (UV) lamp tube; and the UV lamp tube disinfects the inside of the pet feeder.

6. The pet feeder according to claim 4, wherein a top end of the sealing cover plate is provided with an ambient lamp

7. The pet feeder according to claim 4, wherein the division structure comprises a guide base plate and a guide device; the guide base plate is located at a bottom end of the protecting shell; the guide device is arranged on the inner side of a bottom end of the guide base plate; and the guide device guides the pet food.

8. The pet feeder according to claim 7, wherein a feeding end of the distribution tube is connected to a side wall of the guide base plate; and the distribution tube is adjusted and replaced according to a requirement of a division port.

9. The pet feeder according to claim 1, wherein the food plate structure comprises a food plate base and a food plate; the food plate is arranged in the food plate base; the food plate is matched with the distribution tube; a bottom end of the food plate base is provided with an adjustment slot; and the adjustment slot adjusts a height of the feeder.

10. The pet feeder according to claim 9, wherein a partition is arranged in the middle of the food plate base, and separates the food plate base into two partitions.

11. The pet feeder according to claim 4, wherein an indicator lamp module, a button module, a detection module and a sound module which are electrically connected to the controller are also arranged inside the main unit structure; the sound module is used for recording sounds and playing the recorded sounds or prompt tones; the indicator lamp is used for displaying a state indication and achieving digital displaying; the button module is used for setting different functions; and the detection module is used for detecting remaining food, in-position, food blocking, power supplying of a battery and battery power.

12. The pet feeder according to claim 11, wherein the sound module comprises a microphone and a horn; the microphone is used for recording sounds; and the horn is used for playing the recorded sounds or prompt tones.

13. The pet feeder according to claim 11, wherein the indicator lamp module comprises displaying time, displaying the number of parts, displaying the number of meals, a power lamp, a lock lamp, a state lamp, and displaying insufficient food, and is used for displaying a state indication and achieving digital displaying.

14. The pet feeder according to claim 11, wherein the button module comprises a UV lamp turn-on/turn-off button, a lighting lamp turn-on/turn-off button, a “+” button, a “−” button, an unlock button, a setting button, a record button and a manual feeding reset button; the UV lamp turn-on/turn-off button controls the UV lamp to be turned on or turned off; the lighting lamp turn-on/turn-off button controls the lighting lamp to be turned on or turned off; the “+” button and the “−” button are respectively used for adjusting the feeding time, the number of meals and the number of parts; the unlock button achieves unlocking; the record button performs record setting; and the manual feeding reset button achieves direct manual feeding.

15. The pet feeder according to claim 14, wherein the button module comprises physical buttons and touch buttons.
